(19) United States
(12) Patent Application Publication
(10) Pub. No.: US 2011/0303435 A1
(43) Pub. Date: Dec. 15, 2011

(54) ALUMINUM ALLOY CONDUCTOR CABLE AND METHOD FOR MANUFACTURING THE SAME

(75) Inventors: Jee Yong PARK, Seongnam-si (KR); Sang Kyum KIM, Anyang-si (KR); Seung LEE, Anyang-si (KR); IL JO KWAK, Seoul (KR)

(73) Assignee: LS CABLE LTD., Anyang-si (KR)

(21) Appl. No.: 13/156,841

(22) Filed: Jun. 9, 2011

(30) Foreign Application Priority Data
Jun. 15, 2010 (KR) 10-2010-0056515

(51) Int. Cl. H01B 5/00; H01R 43/00

(52) U.S. Cl. 174/126.1; 29/825

(57) ABSTRACT

Optimum compositional elements and contents (wt %) of an aluminum alloy conductor cable are newly established to enhance rigidity against vibration and electrical conductivity of the aluminum alloy conductor cable. Further, a process for the aluminum alloy conductor cable is presented to provide an aluminum alloy conductor cable having satisfactory tensile strength (mechanical strength) and electrical conductivity.

### CROSS-REFERENCE TO RELATED APPLICATION

This application claims priority to Korean Patent Application No. 10-2010-0056515, filed on Jun. 15, 2010, and all the benefits accruing therefrom under 35 U.S.C. §119, the contents of which in its entirety are herein incorporated by reference.

### BACKGROUND

1. Field

This disclosure relates to an aluminum alloy conductor cable and a method for manufacturing the same. More particularly, the disclosure provides optimum compositional elements and contents (wt %) of an aluminum alloy conductor cable for improving rigidity against vibration and electrical conductivity (% IACS, International Annealed Copper Standard), and a method for manufacturing the aluminum alloy conductor cable.

2. Description of the Related Art

Aluminum alloy conductor cables are widely used in various fields, including power cables, automobiles, airplanes, motors and other power equipments, since they are lighter and inexpensive, are casted easily, form alloys easily with other metals, are easier to process at normal and elevated temperatures, and have better corrosion resistance and durability in the atmosphere, as compared to silver or copper conductor cables and copper alloy conductor cables.

The aluminum alloy conductor cables include hard-drawn aluminum alloy conductor cables, multistrand cables obtained by twisting hard-drawn aluminum wires, and so forth. In general, copper conductor cable or copper alloy conductor cable strands obtained through continuous casting or hot rolling process are processed into desired products through cold drawing.

Although most aluminum alloy conductor cables include iron (Fe), copper (Cu), zirconium (Zr) and silicon (Si) components to ensure desired tensile strength (mechanical strength) and electrical conductivity, the tensile strength and electrical conductivity are still unsatisfactory.

For this reason, the aluminum alloy conductor cables are restricted a lot in terms of applications and uses. As a result, there is a limit in reducing cost since the copper conductor cables or copper alloy conductor cables are not replaced by the aluminum alloy conductor cables.

As such, studies are actively carried out in the field of cable manufacturing in order to further improve the tensile strength (mechanical strength) and electrical conductivity so as to replace the copper conductor cables and copper alloy conductor cable with the aluminum alloy conductor cables. However, there remain a lot of difficulties since the optimum compositions for the aluminum alloy conductor cable and the processes for the manufacture thereof are not established.

### SUMMARY

This disclosure is directed to establishing optimum compositional elements and contents (wt %) of an aluminum alloy conductor cable and a manufacturing technique thereof, in order to provide an aluminum alloy conductor cable having satisfactory tensile strength (mechanical strength) and electrical conductivity and a method for manufacturing the same.

In one aspect, there is provided an aluminum alloy conductor cable including aluminum (Al), iron (Fe), copper (Cu), magnesium (Mg), silicon (Si), zinc (Zn) and other elements (impurities).

The aluminum alloy conductor cable may have a tensile strength of 10-20 kgf/mm², a stretch ratio of 15-35% and an electrical conductivity of 55-62% IACS; and a ratio of the lengths of aluminum alloy particles arranged in a length direction of the aluminum alloy conductor cable in the transverse and longitudinal directions may satisfy Equation 5 and a distribution of the particles in a unit area (0.01 mm²=100 μm×100 μm) may be 45-80%:

$$0.2 \leq \frac{a}{b} < 10 \qquad Equation 5$$

where a is the length of the particles in the transverse direction, and b is the length of the particles in the longitudinal direction.

In another aspect, there is provided a method for manufacturing an aluminum alloy conductor cable, including: preparing an alloy material comprising Al, Fe, Cu, Mg, Si and Zn; processing into desired shape and outer diameter at cold state; performing wire drawing; performing heat treatment; and finishing the manufacture of an aluminum alloy conductor cable.

By newly establishing optimum compositional elements and contents (wt %) of an aluminum alloy conductor cable as well as a technique for manufacturing the same, this disclosure provides an aluminum alloy conductor cable with superior tensile strength (mechanical strength) and electrical conductivity.

With sufficiently superior tensile strength (mechanical strength) and electrical conductivity, the disclosed aluminum alloy conductor cable is applicable to wires for automobiles, which require particularly superior electrical conductivity and tensile strength (mechanical strength) against vibration, as well as other cables.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1A is a graph showing change in tensile strength and electrical conductivity of an aluminum alloy conductor cable according to this disclosure depending on silicon (Si) content (wt %);

FIG. 1B is a graph showing change in tensile strength and electrical conductivity of an aluminum alloy conductor cable according to this disclosure depending on zinc (Zn) content (wt %);

FIG. 1C is a graph showing change in tensile strength and electrical conductivity of an aluminum alloy conductor cable according to this disclosure depending on Si+Zn content (wt %);

FIG. 2A is a graph showing change in tensile strength and stretch ratio of an aluminum alloy conductor cable according to this disclosure depending on the content (wt %) of iron (Fe)+copper (Cu)+magnesium (Mg)+Si+Zn+other elements (impurities);

FIG. 2B is a graph showing change in electrical conductivity of an aluminum alloy conductor cable according to this disclosure depending on the content (wt %) of Fe+Cu+Mg+Si+Zn+ other elements (impurities);

FIG. 3 schematically illustrates an aluminum alloy conductor cable according to this disclosure; and

FIG. 4 is a flow chart illustrating a method for manufacturing an aluminum alloy conductor cable according to this disclosure.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and this disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, an aluminum alloy conductor cable and a method for manufacturing the same according to this disclosure will be described in detail.

An aluminum alloy conductor cable according to this disclosure comprises aluminum (Al), iron (Fe), copper (Cu), magnesium (Mg), silicon (Si), zinc (Zn) and other elements (impurities). The contents of Al, Fe, Cu, Mg, Si, Zn and other elements (impurities) may satisfy Equations 1 and 2:

97.42 (wt %)≦Al≦99.8 (wt %)

0.05 (wt %)≦Fe≦1.0 (wt %)

0.05 (wt %)≦Cu≦1.0 (wt %)

0.04 (wt %)≦Mg≦1.0 (wt %)

0.001 (wt %)≦Si≦0.03 (wt %)

0.001 (wt %)≦Zn≦0.04 (wt %)

0.008 (wt %)≦other elements (impurities)≦0.03 (wt %)

0.15 (wt %)≦Fe+Cu≦1.5 (wt %)

0.002 (wt %)≦Si+Zn≦0.05 (wt %)

0.15 (wt %)≦Fe+Mg≦1.5 (wt %) Equation 1

0.15 (wt %)≦Fe+Cu+Mg+Si+Zn+other elements (impurities)≦3.1 (wt %) Equation 2

In an aluminum alloy conductor cable according to this disclosure, the addition amount (wt %) of Fe and Cu is limited. Table 1 shows change in tensile strength and electrical conductivity of an aluminum alloy conductor cable according to this disclosure depending on contents (wt %) of Fe, Cu and Fe+Cu.

TABLE 1

| | | | Physical properties | | |
|---|---|---|---|---|---|
| | | | Tensile | Electrical | |
| Content (wt %) | | | strength | conductivity | |
| Fe + Cu | Fe | Cu | (kgf/mm²) | (% IACS) | Result |
| 0.10 | 0.05 | 0.05 | 7 | 61 | Unsatisfactory |
| 0.12 | 0.05 | 0.07 | 8 | 61 | Unsatisfactory |
| | 0.07 | 0.05 | 8 | 61 | Unsatisfactory |
| 0.15 | 0.04 | 0.11 | 9 | 60 | Unsatisfactory |
| | 0.05 | 0.10 | 10 | 59 | Satisfactory |
| | 0.07 | 0.08 | 11 | 59 | Satisfactory |
| | 0.08 | 0.07 | 11 | 59 | Satisfactory |
| | 0.10 | 0.05 | 12 | 59 | Satisfactory |
| | 0.11 | 0.04 | 12 | 54 | Unsatisfactory |
| | 0.04 | 0.96 | 13 | 54 | Unsatisfactory |
| 1.00 | 0.05 | 0.95 | 12 | 55 | Satisfactory |
| | 0.50 | 0.50 | 14 | 57 | Satisfactory |
| | 0.95 | 0.05 | 12 | 55 | Satisfactory |
| | 0.96 | 0.04 | 14 | 53 | Unsatisfactory |
| 1.50 | 1.05 | 0.45 | 15 | 53 | Unsatisfactory |
| | 1.00 | 0.50 | 16 | 55 | Satisfactory |
| | 0.75 | 0.75 | 17 | 55 | Satisfactory |
| | 0.50 | 1.00 | 18 | 55 | Satisfactory |
| | 0.45 | 1.05 | 19 | 52 | Unsatisfactory |
| 1.55 | 0.75 | 0.80 | 18 | 54 | Unsatisfactory |
| | 0.80 | 0.75 | 17 | 54 | Unsatisfactory |
| 1.60 | 0.80 | 0.80 | 18 | 54 | Unsatisfactory |

As seen from the experimental data in Table 1, if the addition amount (wt %) of Fe+Cu is 0.15 wt %, satisfactory electrical conductivity and tensile strength (mechanical strength) are attained when the addition amount (wt %) of Fe is 0.05-0.10 wt % and the addition amount (wt %) of Cu is 0.05-0.10 wt %.

And, if the addition amount (wt %) of Fe+Cu is 1.00 wt %, superior electrical conductivity and tensile strength (mechanical strength) are attained when the addition amount (wt %) of Fe is 0.05-0.95 wt % and the addition amount (wt %) of Cu is 0.05-0.95 wt %.

And, if the addition amount (wt %) of Fe+Cu is 1.50 wt %, superior electrical conductivity and tensile strength (mechanical strength) are attained when the addition amount (wt %) of Fe is 0.50-1.00 wt % and the addition amount (wt %) of Cu is 0.50-1.00 wt %.

Thus, in order to stably ensure both tensile strength (mechanical strength) and electrical conductivity, the contents (wt %) of Fe, Cu and Fe+Cu should satisfy Equations 1 and 2.

In an aluminum alloy conductor cable according to this disclosure, the addition amount (wt %) of Fe and Mg is limited. Table 2 shows change in tensile strength and electrical conductivity of an aluminum alloy conductor cable according to this disclosure depending on contents (wt %) of Fe, Mg and Fe+Mg.

TABLE 2

| | | | Physical properties | | |
|---|---|---|---|---|---|
| | | | Tensile | Electrical | |
| Content (wt %) | | | strength | conductivity | |
| Fe + Mg | Fe | Mg | (kgf/mm²) | (% IACS) | Result |
| 0.10 | 0.05 | 0.05 | 7 | 61 | Unsatisfactory |
| 0.12 | 0.05 | 0.07 | 8 | 59 | Unsatisfactory |
| | 0.07 | 0.05 | 7.5 | 60 | Unsatisfactory |
| 0.15 | 0.04 | 0.11 | 9 | 61 | Unsatisfactory |
| | 0.05 | 0.10 | 10 | 59 | Satisfactory |
| | 0.07 | 0.08 | 10 | 58 | Satisfactory |
| | 0.08 | 0.07 | 11 | 59 | Satisfactory |
| | 0.11 | 0.04 | 11 | 56 | Satisfactory |
| | 0.12 | 0.03 | 13 | 54 | Unsatisfactory |
| 1.00 | 0.04 | 0.96 | 17 | 51 | Unsatisfactory |
| | 0.05 | 0.95 | 10 | 59 | Satisfactory |
| | 0.50 | 0.50 | 16 | 56 | Satisfactory |
| | 0.96 | 0.04 | 11 | 57 | Satisfactory |
| | 0.97 | 0.03 | 12 | 54 | Unsatisfactory |
| 1.50 | 1.05 | 0.45 | 14 | 53 | Unsatisfactory |
| | 1.00 | 0.50 | 16 | 55 | Satisfactory |
| | 0.75 | 0.75 | 13 | 56 | Satisfactory |
| | 0.50 | 1.00 | 15 | 55 | Satisfactory |
| | 0.45 | 1.05 | 16 | 52 | Unsatisfactory |
| 1.55 | 0.75 | 0.80 | 16 | 52 | Unsatisfactory |
| | 0.80 | 0.75 | 16 | 51 | Unsatisfactory |
| 1.60 | 0.80 | 0.80 | 18 | 50 | Unsatisfactory |

As seen from the experimental data in Table 2, if the addition amount (wt %) of Fe+Mg is 0.15 wt %, satisfactory electrical conductivity and tensile strength (mechanical strength) are attained when the addition amount (wt %) of Fe is 0.05-0.11 wt % and the addition amount (wt %) of Mg is 0.04-0.10 wt %.

And, if the addition amount (wt %) of Fe+Mg is 1.00 wt %, superior electrical conductivity and tensile strength (mechanical strength) are attained when the addition amount (wt %) of Fe is 0.05-0.96 wt % and the addition amount (wt %) of Mg is 0.04-0.95 wt %.

And, if the addition amount (wt %) of Fe+Mg is 1.50 wt %, superior electrical conductivity and tensile strength (mechanical strength) are attained when the addition amount (wt %) of Fe is 0.50-1.00 wt % and the addition amount (wt %) of Mg is 0.50-1.00 wt %.

Thus, in order to stably ensure both tensile strength (mechanical strength) and electrical conductivity, the contents (wt %) of Fe, Mg and Fe+Mg should satisfy Equations 1 and 2.

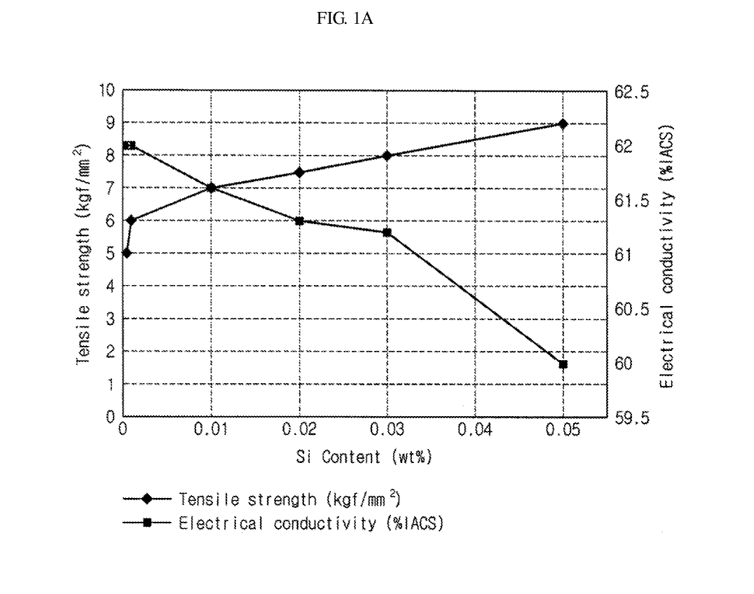

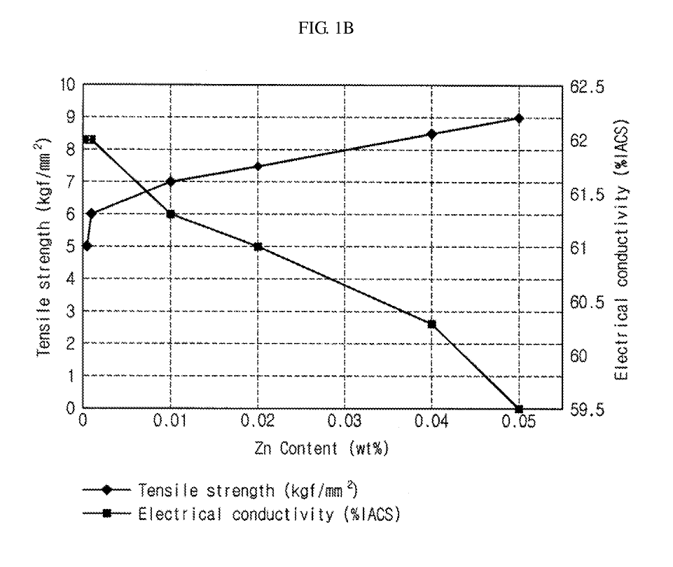

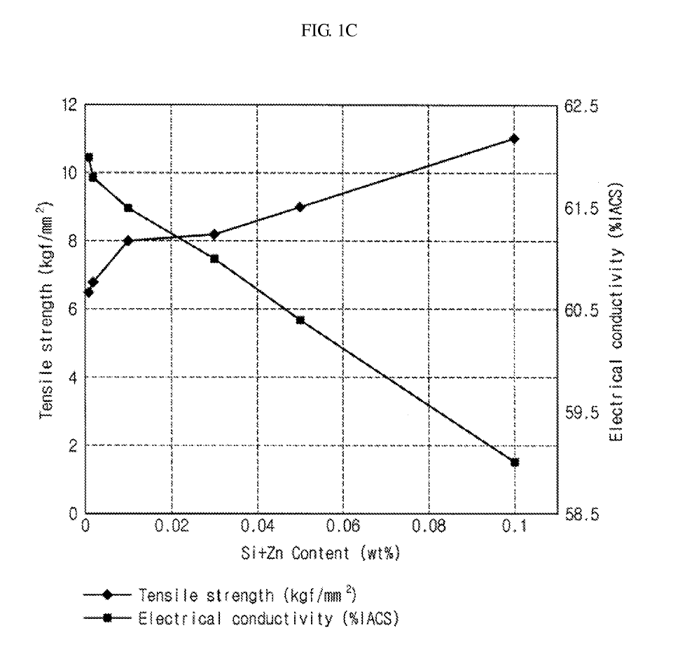

In an aluminum alloy conductor cable according to this disclosure, the addition amount (wt %) of Si and Zn is limited. In this regard, FIG. 1A shows change in tensile strength and electrical conductivity of an aluminum alloy conductor cable according to this disclosure depending on Si content (wt %), FIG. 1B shows change in tensile strength and electrical conductivity of an aluminum alloy conductor cable according to this disclosure depending on Zn content (wt %), and FIG. 10 shows change in tensile strength and electrical conductivity of an aluminum alloy conductor cable according to this disclosure depending on Si+Zn content (wt %).

TABLE 3

| Si | Tensile | Electrical | Zn | Tensile | Electrical | Si + Zn | Tensile | Electrical |
|---|---|---|---|---|---|---|---|---|
| content | strength | conductivity | content | strength | conductivity | content | strength | conductivity |
| (wt %) | (kgf/mm²) | (% IACS) | (wt %) | (kgf/mm²) | (% IACS) | (wt %) | (kgf/mm²) | (% IACS) |
| 0.0005 | 5 | 62 | 0.0005 | 5 | 62 | 0.001 | 6.5 | 62 |
| 0.001 | 6 | 62 | 0.001 | 6 | 62 | 0.002 | 6.8 | 61.8 |
| 0.01 | 7 | 61.6 | 0.01 | 7 | 61.3 | 0.01 | 8 | 61.5 |
| 0.02 | 7.5 | 61.3 | 0.02 | 7.5 | 61 | 0.03 | 8.2 | 61 |
| 0.03 | 8 | 61.2 | 0.04 | 8.5 | 60.3 | 0.05 | 9 | 60.4 |
| 0.05 | 9 | 60 | 0.05 | 9 | 59.5 | 0.1 | 11 | 59 |

As seen from the experimental data in Table 3 and the graphs of FIGS. 1A to 1C, if the addition amount (wt %) of Si is less than 0.001 wt % or if the addition amount (wt %) of Zn is less than 0.001 wt %, tensile strength (mechanical strength) is not good although superior electrical conductivity may be attained.

And, if the addition amount (wt %) of Si+Zn is less than 0.002 wt %, tensile strength (mechanical strength) is not good although superior electrical conductivity may be attained.

On the contrary, if the addition amount (wt %) of Si exceeds 0.03 wt % or if the addition amount (wt %) of Zn exceeds 0.04 wt %, electrical conductivity is not good although superior tensile strength (mechanical strength) may be attained.

And, if the addition amount (wt %) of Si+Zn exceeds 0.05 wt %, electrical conductivity is not good.

Thus, in order to stably ensure both tensile strength (mechanical strength) and electrical conductivity, the contents (wt %) of Si and Zn should satisfy Equations 1 and 2.

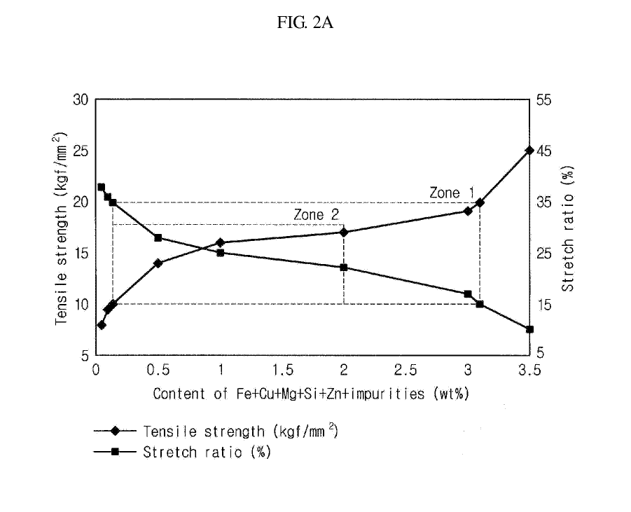

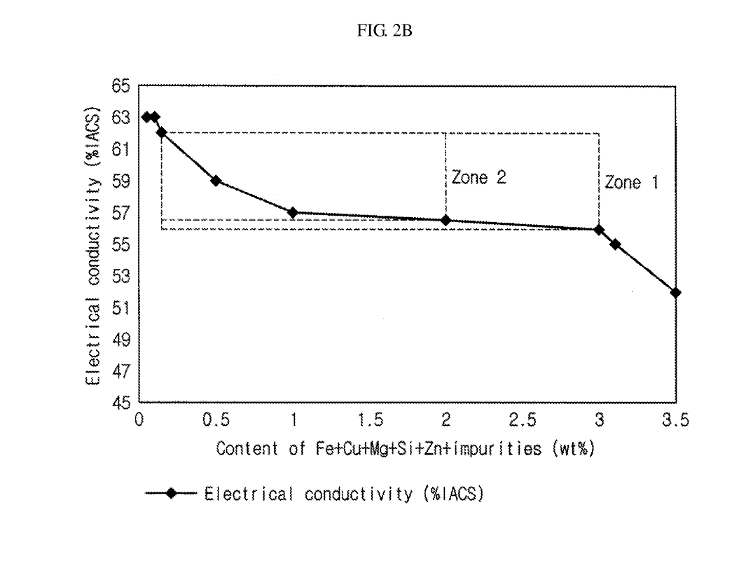

More specifically, as seen from the experimental data in Table 4 and the graphs of FIGS. 2A and 2B, superior tensile strength (mechanical strength) and electrical conductivity may be attained when Equations 3 and 4 are satisfied.

FIG. 2A shows change in tensile strength and stretch ratio of an aluminum alloy conductor cable according to this disclosure depending on the content (wt %) of Fe+Cu+Mg+Si+Zn+other elements (impurities), and FIG. 2B shows change in electrical conductivity of an aluminum alloy conductor cable according to this disclosure depending on the content (wt %) of Fe+Cu+Mg+Si+Zn+other elements (impurities).

TABLE 4

| | | | Tensile | Stretch | Electrical |
|---|---|---|---|---|---|
| Fe + Cu + Mg + Si + | | | strength | ratio | conductivity |
| Zn + impurities (wt %) | | | (kgf/mm²) | (%) | (% IACS) |
| Below lower limit | | 0.05 | 8 | 38 | 63 |
| | | 0.1 | 9.5 | 36 | 63 |
| Zone 1 | Zone 2 | 0.15 | 10 | 35 | 62 |
| | | 0.5 | 14 | 28 | 59 |
| | | 1 | 16 | 25 | 57 |
| | | 2 | 17 | 22 | 56.5 |
| | | 3 | 19 | 17 | 56 |
| | | 3.1 | 20 | 15 | 55 |

| | | | | |
|---|---|---|---|---|
| Above upper limit | 3.5 | 25 | 10 | 52 |

98 (wt %)≦Al≦99.8 (wt %)

0.05 (wt %)≦Fe≦1.0 (wt %)

0.05 (wt %)≦Cu≦1.0 (wt %)

0.04 (wt %)≦Mg≦1.0 (wt %)

0.001 (wt %)≦Si≦0.03 (wt %)

0.001 (wt %)≦Zn≦0.04 (wt %)

0.008 (wt %)≦other elements (impurities)≦0.03 (wt %)

0.15 (wt %)≦Fe+Cu≦1.5 (wt %)

0.002 (wt %)≦Si+Zn≦0.05 (wt %)

0.15 (wt %)≦Fe+Mg≦1.5 (wt %) Equation 3

0.15 (wt %)≦Fe+Cu+Mg+Si+Zn+other elements (impurities)≦2 (wt %) Equation 4

As seen from the experimental data in Table 4 and the graphs of FIGS. 2A and 2B, zone 1 with satisfactory tensile strength, stretch ratio and electrical conductivity satisfies the relationship 0.15 (wt %)≦Fe+Cu+Mg+Si+Zn+other elements (impurities)≦3.1 (wt %), i.e. Equation 2.

More specifically, zone 2 satisfying the relationship 0.15 (wt %)≦Fe+Cu+Mg+Si+Zn+other elements (impurities)≦2 (wt %), i.e. Equation 4, gives an optimum result.

For example, if the content (wt %) of Fe+Cu+Mg+Si+Zn+other elements (impurities) is less than 0.15 wt %, tensile strength (mechanical strength) is not good.

On the contrary, if the content (wt %) of Fe+Cu+Mg+Si+Zn+other elements (impurities) exceeds 3.1 wt %, electrical conductivity and stretch ratio are not good.

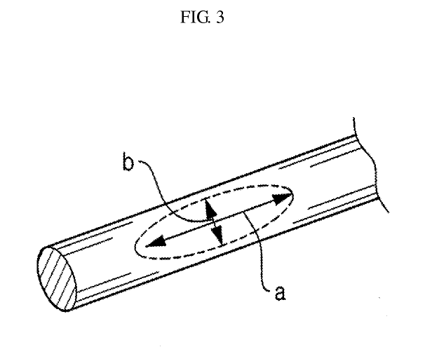

FIG. 3 schematically illustrates an aluminum alloy conductor cable according to this disclosure.

As seen from the figure, a ratio of the lengths a, b of aluminum alloy particles arranged in a length direction of the aluminum alloy conductor cable in the transverse and longitudinal directions may satisfy Equation 5. And, a distribution of the particles in a unit area (0.01 mm²=100 μm×100 μm) may be 45-80%, more specifically 50-70%.

$$0.2 \leq \frac{a}{b} < 10 \qquad Equation 5$$

Table 5 shows change in tensile strength and stretch depending on the ratio of the lengths a, b of the aluminum alloy particles in the transverse and longitudinal directions and the distribution (%) thereof.

TABLE 5

| | Distribution | Tensile strength | Stretch | |
|---|---|---|---|---|
| a/b | range (%) | (kgf/mm²) | ratio (%) | Result |
| 0.1 | 30 | 21 | 11 | Unsatisfactory |
| | 50 | 20 | 13 | Unsatisfactory |
| | 70 | 19 | 13 | Unsatisfactory |
| | 90 | 18 | 14 | Unsatisfactory |
| 0.2 | 30 | 20 | 13 | Unsatisfactory |
| | 50 | 18 | 15 | Satisfactory |
| | 70 | 17 | 17 | Satisfactory |
| | 90 | 18 | 14 | Unsatisfactory |
| 1 | 30 | 18 | 14 | Unsatisfactory |
| | 50 | 15 | 32 | Satisfactory |
| | 70 | 14 | 34 | Satisfactory |
| | 90 | 8 | 35 | Unsatisfactory |
| 5 | 30 | 9 | 27 | Unsatisfactory |
| | 50 | 17 | 25 | Satisfactory |
| | 70 | 19 | 22 | Satisfactory |
| | 90 | 21 | 11 | Unsatisfactory |
| 8 | 30 | 22 | 7 | Unsatisfactory |
| | 50 | 20 | 15 | Satisfactory |
| | 70 | 19 | 17 | Satisfactory |
| | 90 | 18 | 14 | Unsatisfactory |
| 11 | 30 | 21 | 8 | Unsatisfactory |
| | 50 | 21 | 8 | Unsatisfactory |
| | 70 | 22 | 7 | Unsatisfactory |
| | 90 | 24 | 5 | Unsatisfactory |

For example, an automobile cable should have a tensile strength of 10-20 kgf/mm² and a stretch ratio of 15-35%. An aluminum alloy conductor cable which does not satisfy Equation 5 and is outside the above distribution range cannot have the desired tensile strength and stretch ratio. As a result, unsatisfactory results such as fracture may occur.

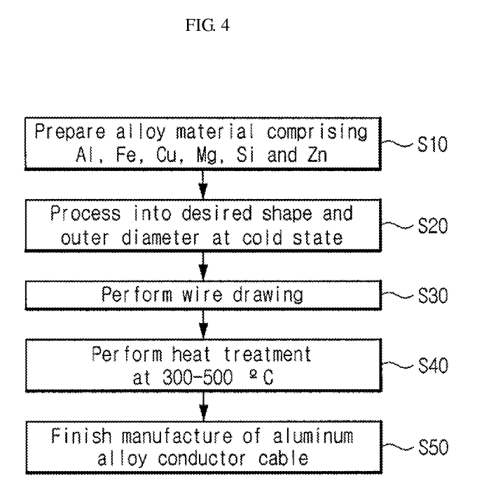

FIG. 4 is a flow chart illustrating a method for manufacturing an aluminum alloy conductor cable according to this disclosure.

As seen in the figure, a method for manufacturing an aluminum alloy conductor cable includes: preparing an alloy material comprising Al, Fe, Cu, Mg, Si and Zn is (10); processing into desired shape and outer diameter, such as a bar, at cold state (20); performing wire drawing (30); performing heat treatment at 300-500° C. (40); and finishing the manufacture of an aluminum alloy conductor cable (50).

The wire drawing is a process by which a wire is pulled through a die in order to attain a wire with desired shape and dimension.

Table 6 shows change in tensile strength, stretch ratio and electrical conductivity depending on the heat treatment temperature.

TABLE 6

| Heat treatment | Tensile strength | Stretch | Electrical conduc- |
|---|---|---|---|
| temperature (° C.) | (kgf/mm²) | ratio (%) | tivity (% IACS) |
| 150 | 20 | 7 | 55 |
| 250 | 18 | 10 | 55 |
| 300 | 16 | 25 | 57 |
| 400 | 14 | 28 | 60 |
| 500 | 11 | 30 | 61 |
| 550 | 8 | 33 | 62 |
| 600 | 4 | 34 | 62 |

As seen from the experimental data in Table 6, the best tensile strength, stretch ratio and electrical conductivity are attained when the heat treatment temperature is 300-500° C.

During said finishing of the manufacture of the aluminum alloy conductor cable, precipitates (compounds of the compositional elements) are formed at the boundary and inside of the particles.

TABLE 7

| Diameter | Distribution | Tensile strength | Stretch | |
|---|---|---|---|---|
| (φ) | range (%) | (kgf/mm²) | ratio (%) | Result |
| 1 | 1 | 20 | 28 | Satisfactory |
| | 3 | 19 | 29 | Satisfactory |
| | 5 | 14 | 30 | Satisfactory |
| | 10 | 9 | 36 | Unsatisfactory |
| 5 | 1 | 18 | 29 | Satisfactory |
| | 3 | 17 | 27 | Satisfactory |
| | 5 | 15 | 26 | Satisfactory |
| | 10 | 12 | 14 | Unsatisfactory |
| 50 | 1 | 12 | 16 | Satisfactory |
| | 3 | 10 | 20 | Satisfactory |
| | 5 | 10 | 21 | Satisfactory |
| | 10 | 9 | 14 | Unsatisfactory |
| 80 | 1 | 8 | 12 | Unsatisfactory |
| | 3 | 7 | 11 | Unsatisfactory |
| | 5 | 5 | 11 | Unsatisfactory |
| | 10 | 4 | 10 | Unsatisfactory |

As seen from the experimental data in Table 7, the precipitates may cause cracking under a stress.

To avoid this problem, the precipitates may have a diameter of 1-50 μm and may exist in an amount of 5% or less in an unit area (0.01 mm²=100 μm×100 μm).

If the precipitates have a diameter of 1-50 μm and exist in an amount exceeding 5% in the unit area, tensile strength or stretch ratio is degraded. As a result, cracking and fracture occur easily when vibration is applied thereto.

And, if the precipitates have a diameter exceeding 50 μm, tensile strength and stretch ratio are degraded without regard to their distribution. As a result, cracking and fracture occur easily when vibration is applied thereto.

Especially, for an automobile cable requiring a tensile strength of 10-20 kgf/mm² and a stretch ratio of 15-35%, an aluminum alloy conductor cable outside the above range cannot have the desired tensile strength and stretch ratio. As a result, unsatisfactory results such as fracture may occur.

Therefore, when the cable is installed at a location where vibration is applied, the precipitates may have a diameter of 1-50 μm and may exist in an amount of 5% or less in the unit area.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. An aluminum alloy conductor cable comprising aluminum (Al), iron (Fe), copper (Cu), magnesium (Mg), silicon (Si), zinc (Zn) and impurities.

2. The aluminum alloy conductor cable according to claim 1, wherein the contents of Al, Fe, Cu, Mg, Si, Zn and impurities satisfy Equations 1 and 2:
97.42 (wt %)≦Al≦99.8 (wt %)
0.05 (wt %)≦Fe≦1.0 (wt %)
0.05 (wt %)≦Cu≦1.0 (wt %)
0.04 (wt %)≦Mg≦1.0 (wt %)
0.001 (wt %)≦Si≦0.03 (wt %)
0.001 (wt %)≦Zn≦0.04 (wt %)
0.008 (wt %)≦impurities≦0.03 (wt %)
0.15 (wt %)≦Fe+Cu≦1.5 (wt %)
0.002 (wt %)≦Si+Zn≦0.05 (wt %)
0.15 (wt %)≦Fe+Mg≦1.5 (wt %) Equation 1
0.15 (wt %)≦Fe+Cu+Mg+Si+Zn+impurities≦3.1 (wt %)

3. The aluminum alloy conductor cable according to claim 1, wherein the contents of Al, Fe, Cu, Mg, Si, Zn and impurities satisfy Equations 3 and 4:
98 (wt %)≦Al≦99.8 (wt %)
0.05 (wt %)≦Fe≦1.0 (wt %)
0.05 (wt %)≦Cu≦1.0 (wt %)
0.04 (wt %)≦Mg≦1.0 (wt %)
0.001 (wt %)≦Si≦0.03 (wt %)
0.001 (wt %)≦Zn≦0.04 (wt %)
0.008 (wt %)≦impurities≦0.03 (wt %)
0.15 (wt %)≦Fe+Cu≦1.5 (wt %)
0.002 (wt %)≦Si+Zn≦0.05 (wt %)
0.15 (wt %)≦Fe+Mg≦1.5 (wt %) Equation 3
0.15 (wt %)≦Fe+Cu+Mg+Si+Zn+impurities≦2 (wt %) Equation 4

4. The aluminum alloy conductor cable according to claim 1, wherein the aluminum alloy conductor cable has a tensile strength of 10-20 kgf/mm², a stretch ratio of 15-35% and an electrical conductivity of 55-62% IACS; and a ratio of the lengths of aluminum alloy particles arranged in a length direction of the aluminum alloy conductor cable in the transverse and longitudinal directions satisfies Equation 5 and a distribution of the particles in a unit area (0.01 mm²=100 μm×100 μm) is 45-80%:
$$0.2 \leq \frac{a}{b} < 10 \qquad Equation 5$$
where a is the length of the particles in the transverse direction, and b is the length of the particles in the longitudinal direction.

5. A method for manufacturing an aluminum alloy conductor cable, comprising:
preparing an alloy material comprising aluminum (Al), iron (Fe), copper (Cu), magnesium (Mg), silicon (Si) and zinc (Zn);
processing into desired shape and outer diameter at cold state;
performing wire drawing;
performing heat treatment; and
finishing the manufacture of an aluminum alloy conductor cable.

6. The method for manufacturing an aluminum alloy conductor cable according to claim 5, wherein the heat treatment is performed at a temperature of 300-500° C.

7. The method for manufacturing an aluminum alloy conductor cable according to claim 5, wherein, in said finishing the manufacture of the aluminum alloy conductor cable, precipitates having a diameter of 1-50 μm are formed and the precipitates exist in an amount of 5% or less in an unit area (0.01 mm²=100 μm×100 μm).
